(19) United States
(12) Patent Application Publication
(10) Pub. No.: US 2008/0208609 A1
(43) Pub. Date: Aug. 28, 2008

(54) SMART INSPECTIONS

(75) Inventors: Dave Preece, Elk Ridge, UT (US); Nate Zobrist, Orem, UT (US); Marcus Daley, Highland, UT (US)

Correspondence Address: KNOBBE MARTENS OLSON & BEAR LLP, 2040 MAIN STREET, FOURTEENTH FLOOR, IRVINE, CA, 92614, US

(73) Assignee: Service Repair Solutions, Inc., Las Vegas, NV (US)

(21) Appl. No.: 12/020,347

(22) Filed: Jan. 25, 2008

Related U.S. Application Data
(60) Provisional application No. 60/886,845, filed on Jan. 26, 2007.

(51) Int. Cl. G06Q 10/00

(52) U.S. Cl. 705/1

(57) ABSTRACT

Systems and methods for customized vehicle inspections are provided. An inspection module is configured to receive data regarding vehicle repairs and repair recommendations from a variety of data sources. From the received data, the inspection module analyzes the repair recommendation and/or repair data indicated in the data received from the data sources in light of factors such as the vehicle repair history and/or driver's driving habits to generate customized inspection checklists for use by repair facilities. These inspection checklists may be further customized, depending on the recipient, for example, consumers, service managers, and technicians, etc), as needed. In this manner, the inspection reports provide improved information which results in better inspections, maintenance decisions, and reporting to consumers.

### CROSS-REFERENCE TO RELATED APPLICATIONS

This application claims the benefit of priority under 35 U.S.C. §119(e) of U.S. Provisional Application No. 60/886,845 filed on Jan. 26, 2007, entitled “Smart Inspections,” which is hereby incorporated by reference in its entirety.

### BACKGROUND OF THE INVENTION

1. Field of the Invention

The invention generally relates to systems methods for customizing an automobile inspection based partly on the automobile make, model, etc., the particular vehicle's inspection and repair history, and/or attributes of the particular vehicle's current driver and/or previous drivers.

2. Description of the Related Art

Automobiles have many components and systems that function alone, or in coordination, to allow proper operation of the vehicle. Examples of such systems and components may include, but are not limited to, brake systems, emissions systems, transmission systems, belts, hoses, fluid levels, tires, etc. In order to ensure that proper operation of the vehicle is maintained, vehicle inspections and repairs are typically recommended by the vehicle manufacturer at selected intervals in order to check the operation of the vehicle's many components and systems.

In order to assist in the inspection and repair process, vehicle inspection forms, lists, or checklists are often utilized. An inspection list provides an inventory of components to check during a vehicle inspection. In one example, such a list may be generated by a vehicle manufacturer. In another example, inspection lists may be generated by individual automobile repair facilities. In this manner, a technician or mechanic can be advised of a variety of systems and/or components to inspect and/or repair.

Unfortunately, these inspection checklists function as “one-size-fits-all” and are used for multiple makes, models, years, etc. of vehicles, each with different drivers and repair histories. Thus, these generic inspection checklists can potentially waste the vehicle owner's time and money, since they may result in inspection of systems that are without problems, while missing unlisted systems that may need repair. Additionally, certain vehicles may have unique repair needs that are not included on generic inspection checklists. Accordingly, there is a need for systems and methods that improve the vehicle inspection process so that the components that are most likely to need service or repair are examined thoroughly, while other components may be more quickly examined or not examined at all.

### SUMMARY OF THE INVENTION

In one embodiment, a computerized method of generating a customized inspection checklist for a particular vehicle comprises determining one or more of a year, make, and model, of a particular vehicle presented at an inspection facility for inspection, locating inspection data for a plurality of similar vehicles each having one or more of a year, make, and model the same as the determined year, make, and model of the particular vehicle, wherein the inspection data comprises a plurality of inspection tasks and corresponding inspection results for the similar vehicles, locating one or more inspection tasks of the inspection data for which a predetermined proportion of the inspection results associated with the similar vehicles indicate that one or more repairs or further inspection should be performed on the respective similar vehicles, and generating a customized inspection checklist including the located inspection tasks.

In another embodiment, a method of determining inspection tasks for inclusion in an inspection checklist for a particular vehicle comprises accessing a data structure comprising indications of a plurality of inspection tasks and associations between respective inspection tasks and respective combinations of one or more of a year, make, and a model of a vehicle, and selecting a first plurality of inspection tasks that are associated with a particular vehicle in the data structure.

In another embodiment, a system for generating an inspection form for use by an automotive technician comprises a computing device configured to receive attributes associated with a particular vehicle, a server in data communication with the computing device, the server storing information regarding repairs that have previously been made to vehicles similar to the particular vehicle, wherein the server provides an indication of those repairs that have been made on similar vehicles at least a threshold number of times and the computing device generates the inspection form comprising inspection recommendations that correspond with the repairs indicated by the server.

### BRIEF DESCRIPTION OF THE DRAWINGS

FIG. 1 is a block diagram of a smart inspection module that is configured to receive data that may be useful in determining inspection tasks to be included on an inspection checklist for a particular vehicle under inspection.

FIG. 2 is a flowchart illustrating one embodiment of a method of receiving data from one or more data sources and analyzing the data in order to determine trends that may be useful in customizing inspection checklists.

FIG. 3 is a block diagram illustrating an exemplary flow of data between a plurality of data sources and a smart inspection module.

FIG. 4 is flowchart illustrating one embodiment of a method of generating a smart inspection checklist for a particular inspection vehicle.

FIG. 5 is a block diagram illustrating an exemplary data flow between a technician device, such as a mobile device that is operated by an inspection technician at the repair facility, and the smart inspection module.

FIGS. 6A-6D illustrate exemplary embodiments of smart inspection checklists that are customized for various users.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

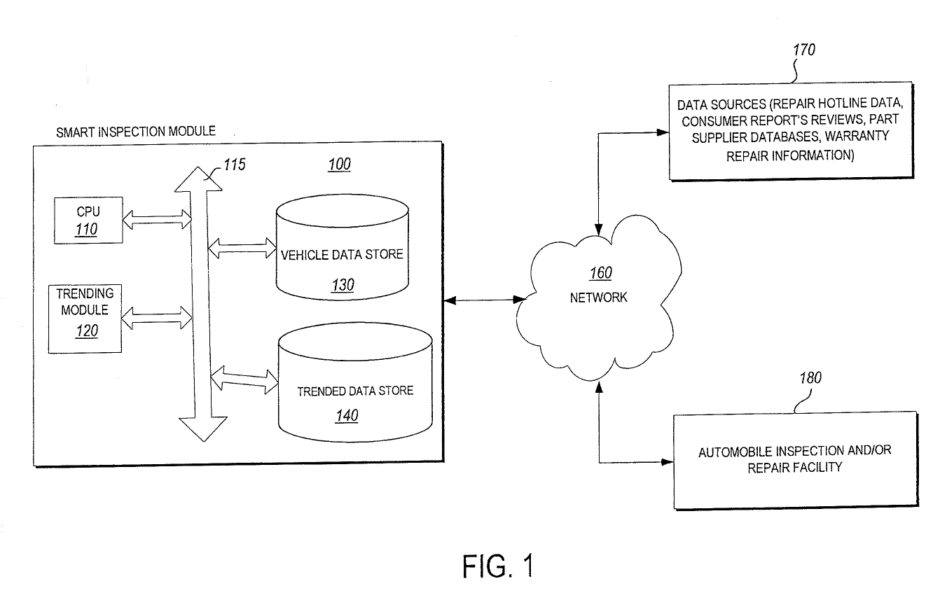

FIG. 1 is a block diagram of a smart inspection module 100 that is configured to generate customized inspection checklists for respective vehicles. In one embodiment, the smart inspection module 100 accesses and/or receives data from one or more data sources 170 that is useful in determining inspection tasks to be included on an inspection report for a particular vehicle under inspection (referred to herein as an “inspection vehicle”). The data sources 170 may include data from one or more of repair hotlines, consumer report data providers, automobile parts suppliers, warranty repair providers, and many other providers of data that is relevant to inspections and/or repairs of automobiles. One specific data source 170 from which data may be received by the smart inspection module 100 is an automobile inspection and/or repair facility 180 (also referred to herein as either an “inspection facility 180” or a “repair facility 180”). For example, data from inspection and repair reports for respective vehicles may be transmitted from the repair facility 180 or otherwise accessed by the smart inspection module 100. In an advantageous embodiment, data from a plurality of repair facilities, such as hundreds, thousands, or more repair facilities, is accessible to the smart inspection module.

In one embodiment, the repair facility 180 comprises a data store that stores data associated with inspection, repairs, and/or repair results, for example, that are performed/observed at the repair facility 180. In one embodiment, the repair facility 180 comprises an automobile repair shop, such as that of a dealership, fleet maintenance depot, or independent mechanic. In another embodiment, the repair facility 180 may comprise the home or workshop of a consumer who performs at least one maintenance operation on a vehicle. In a further embodiment, the repair facility 180 may comprise the location of an individual who desires additional information on vehicle maintenance but does not intend to perform the maintenance themselves.

Advantageously, the smart inspection module analyzes the data received from one or more data sources 170 and generates customized inspection checklists for respective inspection vehicles based at least partly upon the received/accessed data. The terms “vehicle” and “automobile,” as used herein, may comprise any vehicle, automobile, airplane, tractor, boat, or other motorized device, as well as other types of devices that may require inspections and/or repairs, such as electronic devices, including computers and computerized devices, for example. Thus, any reference herein to an automobile or vehicle should be construed to cover any other apparatus or device.

In one embodiment, the smart inspection module 100 identifies inspection tasks that are customized for respective inspection vehicles based on data received from the one or more data sources 170 regarding vehicles similar to the inspection vehicle. In one embodiment, the data received from one or more data sources 170 comprises one or more of symptom reports, recommended inspections and/or repairs, repairs (that were actually performed on respective vehicles), effectiveness of repairs performed, consumer repair inquiry data, warranty information, replacement part sales/use data, and/or any other data that may be useful in determining components of like-kind vehicles that may benefit from inspections and/or repairs. The data received from the data sources 170 may then be used by the smart inspection module to identify trends associated with particular makes, models, mileages, etc., of particular vehicles, such that when the repair facility 180 requests inspection tasks for a particular inspection vehicle, the smart inspection model 100 can provide inspection tasks that are relevant to the particular inspection vehicle.

In one embodiment, the smart inspection module 100 generates a smart inspection checklist (also referred to herein as a “smart inspection report”, or simply a “smart inspection”) comprising one or more inspection tasks that are recommended for the particular inspection vehicle indicated by the automobile repair facility 180, for example. This smart inspection checklist is in contrast to that employed in conventional inspections that include inspection tasks that are generic to large classes of vehicles. As a result, the smart inspection checklist provides pertinent information on topics including, but not limited to, warrantees, recalls, customer surveys, independent reviews, and the experiences of large numbers of mechanics and technicians in an organized and timely manner. Thus, more time and energy can be spent at the repair facility 180 determining and implementing a proper course of action based on the recommendations and additional considerations provided by the smart inspection module 100, rather than gathering such information from scratch or relying on guesswork. This targeted approach, in turn, raises the likelihood of a successful inspection and/or repair outcome at the repair facility 180, saving the customer time and money. These and other advantages of embodiments of the smart inspection module 100 are discussed in detail below.

In the embodiment of FIG. 1, the smart inspection module 100 is in data communication with a network 160, which comprises one or more networks, such as LANs, WANs, and/or the Internet, for example, via a wired and/or wireless communication link. The network 160 is also coupled to one or more data sources 170, such as original equipment manufacturers (OEMs) of automobiles, repair hotline data sources, Consumer Reports review data sources, parts supplier databases, and warranty repair information data sources, discussed in greater detail below. The network 160 is further coupled to one or more automobile inspection and/or repair facilities 180. Depending on the embodiment, the repair facility 180 may serve as both a data source 170, e.g., by providing repair recommendation information for vehicles inspected at the particular repair facility 180, and a user of the customized inspection checklists provided by the smart inspection module 100.

In addition to transferring relevant recommendation and repair data via the network 160, certain data sources 170 may transmit data to the smart inspection module 100 via other means, such as on a moveable media, such as DVD, CD-ROM, flash memory, thumb drive, etc., that may be delivered to an administrator of the smart inspection module 100. In other embodiments, the smart inspection module 100 is in communication with fewer or more devices than are illustrated in FIG. 1. In one embodiment, certain functionalities described herein with respect to the smart inspection module 100 are performed, partly or completely, by other device, such as computing devices of one or more data sources 170 and/or computing devices of the repair facility 180.

In operation, the smart inspection module 100 receives data from the one or more data sources 170 via the network 160 and/or from the repair facility 180. From the received data, the smart inspection module 100 trends the repair recommendation and/or repair data indicated in the data received from the data sources 170, and the smart inspection module 100 provides the trending data to one or more repair facilities 180 in a customized, smart inspection report. In general, trending comprises analyzing historical data for similar vehicles in order to identify possible likely symptoms/repairs of another vehicle (such as an inspection vehicle at the repair facility 180). A trend may be associated with any group of vehicle attributes and may indicate any likely symptoms, likely repair needs, and/or informational items regarding vehicles having the common group of attributes. For example, the repair facility 180 may receive an inspection request from an owner of a 2005 Nissan Maxima. A technician at the repair facility may obtain various information, also referred to as attributes, associated with the Nissan Maxima (the “inspection vehicle”), such as the make, model, year, sub-model, engine specifications, accessory package, mileage, inspection history, and/or repair history, as well as any other relevant attributes of the inspection vehicle. Additionally, the technician may obtain various information associated with one or more drivers of the inspection vehicle, such as profession, driving severity, geographical region and climate of use, as well as any other relevant attributes of the driver(s) of the vehicle. After obtaining one or more vehicle attributes and possibly driver attributes, the technician transmits the obtained attributes to the smart inspection module 100 and, in return, the smart inspection module 100 provides one or more recommended inspection tasks for inclusion on a smart inspection checklist for the particular 2005 Nissan Maxima, wherein the inspection tasks are selected based on at least trended repair and/or recommendation data that has been generated by the smart inspection module 100 based on information received from one or more data sources 170. Further description of the process of generating trended repair and/or recommendation data and use of the trended data in generating smart inspection reports for specific vehicles is provided below.

In the embodiment of FIG. 1, the smart inspection module 100 comprises one or more computing devices. The exemplary smart inspection module 100 comprises a CPU 110, a trending module 120, a data store 130 for storing data received from the one or more data sources 170, and a trended data store 140 for storing trending information regarding the data stored in the data store 130. Depending on the embodiment, the data stores 130, 140 may be comprise a single storage device, such as a hard drive or array of hard drives. In the embodiment of FIG. 1, each of the components 110, 120, 130, 140 are in data communication via one or more buses 115.

In general, the word module, as used herein, refers to logic embodied in hardware or firmware, or to a collection of software instructions, possibly having entry and exit points, written in a programming language, such as C or C++. A software module may be compiled and linked into an executable program, installed in a dynamic link library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an EPROM. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

In one embodiment, the smart inspection module 100 comprises a server based system. In other embodiments, the smart inspection module 100 may comprise any other computing device, such as a computing device or server that is IBM, Macintosh, or Linux/Unix compatible. In another embodiment, the smart inspection module 100 comprises a desktop personal computer (PC), a laptop computer, a cellular phone, personal digital assistant (PDA), a kiosk, or an audio player, for example.

In the embodiment of FIG. 1, the exemplary smart inspection module 100 includes one or more central processing units (“CPU”) 110, which may each include conventional microprocessors or any other processing unit. The smart inspection module 100 further includes one or more memory devices (not shown), such as random access memory (“RAM”) for temporary storage of information and a read only memory (“ROM”) for permanent storage of information, and one or more mass storage devices, such as hard drives, diskettes, or optical media storage devices. In one embodiment, the modules of the smart inspection module 100 are in communication via a standards based bus system 115, such as bus systems using Peripheral Component Interconnect (PCI), Microchannel, SCSI, Industrial Standard Architecture (ISA) and Extended ISA (EISA) architectures and others. In certain embodiments, components of the smart inspection module 100 communicate via one or more networks 160, such as a local area network that may be secured.

The smart inspection module 100 is generally controlled and coordinated by operating system software, such as server based software. In other embodiments, the smart inspection module 100 comprises modules that execute one or more other operating systems, such as Windows 95, Windows 98, Windows NT, Windows 2000, Windows XP, Windows Vista, Linux, SunOS, Solaris, PalmOS, Blackberry OS, or other desktop or server operating systems. In Macintosh systems, the operating system may be any available operating system, such as MAC OS X. In other embodiments, the smart inspection module 100 may be controlled by a proprietary operating system. Conventional operating systems control and schedule computer processes for execution, perform memory management, provide file system, networking, and I/O services, and provide a user interface, such as a graphical user interface (“GUI”), among other things.

The exemplary smart inspection module 100 includes one or more commonly available input/output (I/O) devices and interfaces (not shown), such as a keyboard, mouse, touchpad, speaker, and printer. In one embodiment, the I/O devices and interfaces include one or more display device, such as a monitor, that allows the visual presentation of data to a user. More particularly, a display device provides for the presentation of GUIs, application software data, and multimedia presentations, for example. The smart inspection module 100 may also include one or more multimedia devices, such as speakers, video cards, graphics accelerators, and microphones, for example.

In the exemplary embodiment of FIG. 1, a smart inspection checklist is generated for a specific vehicle to be inspected (the “inspection vehicle”) based on trended data associated with vehicles that are similar to the inspection vehicle (e.g., repair and/or inspection data of vehicles of the same make, model, and mileage band). Beneficially, the customized inspection checklist is based on vehicle data, such as repair and/or recommendation data, for vehicles that are similar to the particular inspection vehicle. Additionally, in certain embodiments, the inspection report is also based on vehicle data that is relevant to a particular driver profile that matches attributes of the driver of the inspection vehicle. Thus, a smart inspection checklist that is used by an inspection/repair technician to perform an inspection a vehicle may include additional inspection items that are not typically on a standard automobile inspection, where the additional inspection items relate to repairs that are commonly necessary on the similar vehicles (e.g., same make, model, engine specifications, year, mileage range of automobile, etc.) and/or that are commonly necessary for drivers having similar attributes to the driver of the inspection vehicle. In this way, the technician that performs the automobile inspection is focused on those areas that are most likely to require repair on the inspection vehicle.

In certain embodiments, the smart inspection checklist may include fewer inspection tasks than are on a standard automobile inspection. For example, the trending data that is generated by the smart inspection module 100 may not include certain standard inspection tasks based on a trend that indicates the particular inspection tasks are not likely to need repair on the particular inspection vehicle. In this embodiment, the technician is provided with additional time to focus on the more relevant inspection tasks, rather than inspecting items for which there is a low probability that a repair is needed.

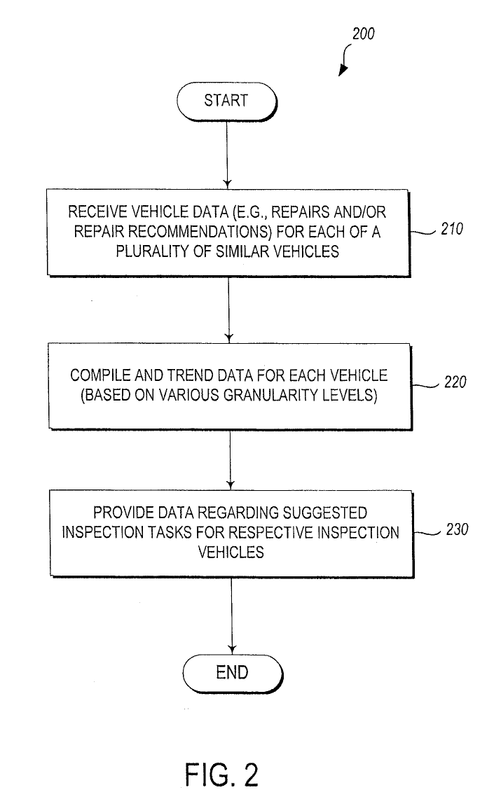

FIG. 2 is a flowchart 200 illustrating one embodiment of a method of receiving data from one or more data sources 170 and analyzing the data in order to determine trends that may be useful in inspections tasks for respective vehicles. As noted above, in one embodiment the smart inspection module 100 (FIG. 1) receives data from the one or more data sources 170, analyzes the data in order to determine trends associated with the received data, and uses the trending data to generate customized inspection checklist tasks for respective inspection vehicles. Depending on the embodiment, certain of the blocks described below may be removed, others may be added, and the sequence of the blocks may be altered.

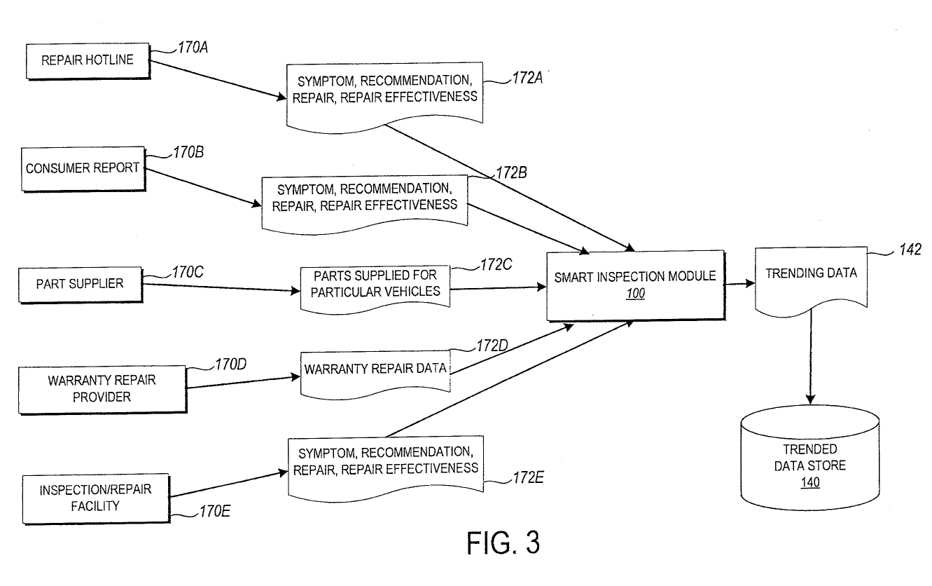

FIG. 3, which will be described in conjunction with FIG. 2, illustrates an exemplary flow of data between a plurality of data sources 170A-170E and the smart inspection module 100, wherein the smart inspection module generates trending data that is stored in the trended data store 140. As indicated above, the smart inspection module 100 may receive data from various data sources, including one or more of vehicle manufacturers, Technical Service Bulletins (TSBs); specific vehicle manufacturers associated with the repair facility; part suppliers, including new parts suppliers, warranty parts suppliers, and used parts suppliers; repair hotline databases, such as the Direct-hit Technician Help Hotline, which collects information about vehicles and vehicle operators who call in with specific symptoms and repair information for respective vehicles; federal, state, and local government testing labs; independent testing labs, such those that operated by Consumers Union and/or published within Consumer Reports™ reviews; reference guidebooks, insurers, mechanics, consumers; and/or any other sources of information regarding vehicles that may be information to owners and/or mechanics of other similar vehicles. In a particular example of FIG. 3, the data sources comprise a repair Hotline 170A, a consumer reporting service 170B, a parts supplier 170C, a warranty repair provider 170D, and an inspection/repair facility 170E. In other embodiments, fewer or additional data sources 170 may provide data to the smart inspection module 100.

Beginning in block 210 (FIG. 2), vehicle data is received from each of a plurality of data sources, such as data sources 170A-170E of FIG. 3. In this embodiment, the one or more data sources 170 transmit (or otherwise allow the smart inspection module 100 to access) the vehicle data, which may comprise repair and/or repair recommendation data from technicians/mechanics, customers, test results, or other sources. In one embodiment, the smart inspection module 100 stores the received vehicle data in the data store 130 (FIG. 1).

In one embodiment, the data sources 170, including the repair facility 180 in one embodiment, upload data to the smart inspection module 100 as the data is entered into their respective databases. In another embodiment, the smart inspection module 100 periodically requests data from certain data sources 170 and/or certain data sources 170 automatically upload data to the smart inspection module 100 on a periodic basis.

Continuing to block 220, the trending module 120 of the smart inspection module 100 analyzes the vehicle data from the data sources 170 and trends the data so that trends associated with similar vehicles are identified and usable in the inspection of the particular inspection vehicle. The term “similar vehicle,” as used herein, comprises vehicles having a group of attributes in common with the inspection vehicles, wherein the attributes are selected from the group comprising vehicle make, model, sub-model, engine specifications, accessory packages, purchase year, manufacture year, inspection/repair history, driving severity, mileage range, and any other attribute that vehicles may have in common. Thus, an inspection vehicle may be associated with multiple groups of similar vehicles, each potentially indicating different trends. For example, similar vehicles of a 2005 Nissan Maxima SE may include a first group of similar vehicles that are newer than 2002, a second group of similar vehicles that are Nissan Maxima SE's, and a third group of similar vehicles that are 2005 Nissan Maxima SE's. In one embodiment, each of the groups of similar vehicles may comprise one or more trends that are useful in determining inspection tasks for the current inspection vehicle. In one embodiment, the most probative trends are associated with the similar vehicles having the most attributes in common with the inspection vehicle.

Trends, in general, indicate some characteristic of multiple similar vehicles that suggest a particular action (or non-action) on other similar vehicles. For example, a trend for a particular inspection vehicle may indicate that (i) mechanics inspecting similar vehicles recommended a particular repair for a large percentage of the similar vehicles, (ii) mechanics inspecting similar vehicles performed a particular repair for a large percentage of the similar vehicles, (iii) a particular repair performed on similar vehicles successfully resolved certain symptoms, (iv) parts purchased for repair of similar vehicles suggest that a particular repair is commonly performed on similar vehicles, and/or (v) inspections of similar vehicles indicate a particular component/system may require repair. Additionally, trends for the inspection vehicle may be determined based more than one of the above-noted exemplary trends, such as repair data and part purchase data for the similar vehicles, and trends may be based on any other data associated with similar vehicles. For example, trends may be generated based on data received from one or more of the data sources 170 associated with similar vehicles having accessories that have been installed on the vehicle post-purchase, such as running boards, ski racks, towing packages, and/or windshield tint, for example.

In certain embodiments, trends for an inspection vehicle may indicate that fewer inspection tasks are prudent for the vehicle. For example, if multiple data sources 170 provided data to the smart inspection module 100 indicating that 2002 and newer models of all Lexus vehicles very rarely require replacement of spark plug prior to reaching 150,000 miles, the trending data for that particular model and year range of vehicles may include a recommendation that examination of spark plugs is not included on a corresponding smart inspection checklist.

With reference to FIG. 3, various vehicle data, such as data regarding recommendations for repair on specific vehicles, actual repairs that were performed on specific vehicles, as well as data regarding symptoms reported by owners/operators of specific vehicles, warranty repair data, replacement part purchase data, and other data relevant to determining inspection tasks for respective vehicles, are illustrated in transit from the various data sources 170A-170E. In particular, the data 172A-172E is illustrated in transit from the data sources to be the smart inspection module 100.

As discussed above, the data 172A-172E may be communicated to the smart inspection module 100 in various formats and may be transmitted and/or accessed at various times and frequencies. Additionally, the content of the data 172A-172E may vary from what is indicated in FIG. 3. With the vehicle data received from the various data sources 170, the trending module 100 is able to generate trending data 142 that indicates inspection tasks that should be considered for vehicles having certain groups of attributes. In one embodiment, inspection tasks suggested by the inspection module 100 are each weighted to indicate a likelihood that respective inspection tasks will result in symptoms that the vehicle owner may want to have repaired or at least would like to be aware of. For example, in one embodiment a ranking of 1-10 may be associated with respective inspection tasks, where a ranking of 10 indicates that the inspection task should definitely be included on smart inspection checklist for corresponding vehicles, while a ranking of 1 indicates that the inspection task may be excluded from smart inspection checklist for corresponding vehicles.

Table 1, below, illustrates a small portion of an exemplary data structure indicating trending data for certain Ford vehicles. As illustrated in table 1, certain inspection tasks are associated with a particular make and model of vehicle, while others are associated with additional vehicle attributes. As is also illustrated in the rank column of FIG. 1, a numerical ranking is provided for each of the listed inspection tasks, wherein the rank is indicative of a likely need for the associated inspection task. In one embodiment, the smart inspection module 100 is configured to provide only inspection tasks having an associated rank that is above a predetermined threshold, for example, above six, to a requesting repair facility 180. In other embodiments, specific repair facilities 180 may determine rank limitations for inspection tasks that are transmitted to the specific repair facility 180. In other embodiments, the data structure comprises additional vehicle attributes, as well as possibly driver attributes. Additionally, in other embodiments various indicators of importance of respective inspection tasks may be included, such as low, medium, and high importance or academic ratings (e.g., A-F) for respective inspection tasks.

TABLE 1

| Make | Model | Year | Mileage | Inspection Task | Rank |
|---|---|---|---|---|---|
| Ford | F-150 | | | Coolant Reservoir | 7 |
| Ford | F-150 | | 75,000+ | Muffler mount | 8 |
| Ford | F-150 | 1998 | | Catalytic Converter | 4 |
| Ford | F-150 | 2004 | 50,000-70,000 | Rear Axel | 7 |

Moving to block 230, the smart inspection module 100 locates smart inspection tasks that are relevant to specific vehicles that are presented for inspection at respective repair facilities, for example. In one embodiment, for example, upon receiving a request for inspection of a particular vehicle, the inspection facility 180 transmits data including vehicle attributes and/or driver attributes to the inspection module 100. In one embodiment, certain attributes of the inspection vehicle may be gathered by cursory examination of the vehicle. Make, model, engine specifications, mileage, and year of a vehicle are generally recognizable features of a vehicle upon quick examination. Further, poor condition of a vehicle for its age may indicate demanding driving habits and/or use of the vehicle, while good condition of a vehicle for its age may indicate the opposite. Similarly, a cursory view of the vehicle may reveal many accessories which have been installed in the vehicle. In another example, certain attributes of the inspection vehicle may be gathered using a DTC code or vehicle identification number (VIN), in combination with records maintained by least one public or private vehicle organization, such those operated by as CarFax™, state governments, and national governments. Such records may be in electronic form, such as a database or in paper form. In a further example, the attributes of the inspection vehicle may be gathered by speaking with the vehicle owner, operator, or manager. Additionally, attributes of the inspection vehicle and/or driver of the vehicle may have previously been stored by a repair facility 180, such as during a previous inspection of the inspection vehicle. Any of the above methods may be employed in any combination to gather vehicle and/or driver attributes.

In response to receiving the vehicle and/or driver attributes, the smart inspection module 100 reviews the trending information stored in the trended data store 140 in order to identify inspection tasks associated with similar vehicles that may be included on a smart inspection checklist for the inspection vehicle. In one embodiment, the smart inspection module 100 provides the recommended inspection tasks to the requesting repair facility 180 and allows the repair facility 180 to generate a corresponding smart inspection checklists, possibly including additional inspection tasks and/or removing certain inspection tasks recommended by the smart inspection module 100. In another embodiment, the smart inspection module 100 generates a smart inspection checklists including the recommended inspection tasks identified by the smart inspection module 100. In one embodiment, the smart inspection may include a first set of inspection items associated with repairs that are likely to be necessary on the particular make and model of car, as well as another set of recommendations that are specific to at least one other attribute of the inspection vehicle, such as mileage range, driver attributes, repair history, etc. The smart inspection may also include inspection task recommendations that are particular to any other one or more attributes associated with the inspection vehicle. In one embodiment, inspection tasks are provided to the repair facility 180 in two or more groups, such as high priority and low priority groups of inspection tasks.

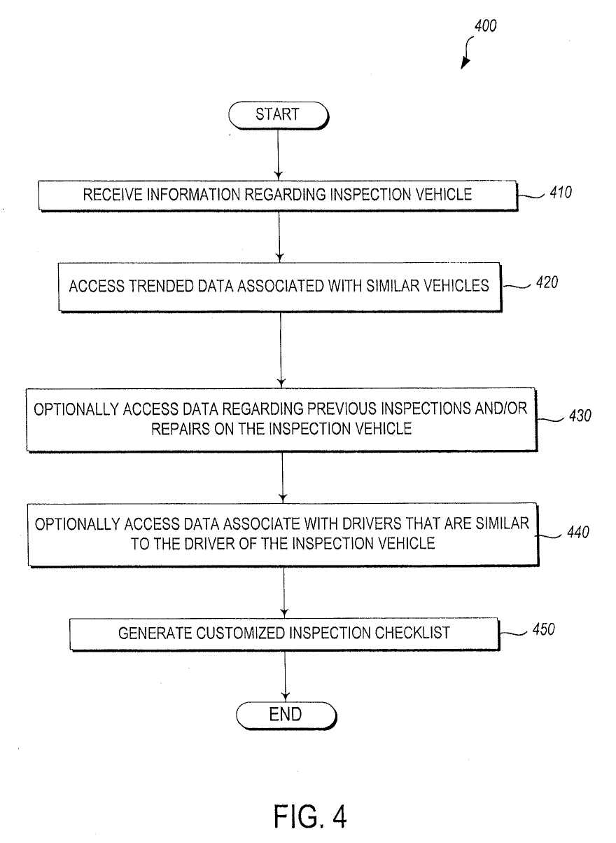

FIG. 4 is a flowchart 400 illustrating one embodiment of a method of generating a smart inspection checklist for a particular inspection vehicle. In one embodiment, the method of FIG. 4 is performed by the smart inspection module 100. In other embodiments, the method of FIG. 4 is performed by a computing device proximate the automobile inspection facility 180, or at another location. In other embodiments, the method of FIG. 4 is performed by multiple computer devices, such as by the smart inspection module 100 and a computer device at the automobile inspection facility 180. Depending on the embodiment, certain of the blocks described below may be removed, others may be added, and the sequence of the blocks may be altered.

Beginning in block 410, vehicle and/or driver attributes associated with the inspection vehicle are received at the inspection module 100, or at another computing device that is configured to access the trending database 140. In one embodiment, the trending database 140 may be stored at additional locations, such as local to the automobile inspection facility 180. In one embodiment, the vehicle attributes comprise a make, model, engine specifications, year, and mileage of the automobile. In further embodiments, the vehicle attributes include at least a portion of the vehicle's repair and maintenance history. Depending on the embodiment, driver attributes may include one or more of an age, driving experience, profession, geographic location of driving and percentage of highway and city driving time as a function of total driving time. In other embodiments, the vehicle and/or driver attributes include fewer or additional attributes.

Moving to block 420, trended data for the particular inspection vehicle is accessed in the database 140. In one embodiment, the trended data indicates the likelihood that certain inspection tasks will result in a “Caution” or “Fail” response by the inspection facility, based on the proportion of “Caution” and “Fail” responses received for the similar vehicles when inspected by technician at one or more of various repair facilities (and/or by technicians at the repair facility that is requesting the smart inspection checklist). For example, if 250 out of 280 inspections of Chevy Vega's resulted in a “Fail” response to the “check oil pressure” task, the inspection module 100 may select the “check oil pressure” task as a high priority task for other Chevy Vega's for which inspection is requested. In other embodiments, other data from other data sources is also utilized in determining high priority tasks for respective inspection vehicles.

Next, in block 430, data regarding previous inspections, repairs, and/or repair recommendations on the inspection vehicle is optionally retrieved and analyzed in order to refine the inspection tasks provided based on the trending data. In one embodiment, block 430 is not performed, e.g., the high priority tasks determined based on trending data associated with the inspection vehicle are used in the smart inspection checklist. In embodiments where block 430 is performed, the smart inspection checklist may be even more specific to the particular needs of the inspection vehicle. For example, the previous repair/recommendation data may indicate that the specific automobile had valve gaskets replaced in the previous year. Accordingly, the smart inspection checklist generated by the smart inspection module 100 may indicate that the valve gaskets should be checked for leaks or other problems in view of the recent replacement of the valve gaskets. In another example, the previous repair/recommendation data may indicate that a major tune up service was performed in advance of a standard maintenance schedule. Accordingly, the smart inspection checklist generated by the smart inspection module 100 may indicate that such a tune up service should not be included at the standard interval. In one embodiment, the data associated with the vehicles serviced by the particular inspection facility 180 is stored local to the inspection facility 180 or at an off-site storage facility. In another embodiment, the historical repair data for a particular vehicle may be transmitted to the smart inspection module 100, may be used in generating the trending data stored in data store 140, and/or accessed by the smart inspection module in the generation of certain smart inspection checklist.

Moving to block 440, trending data associated with the driver profile in which one or more drivers of the inspection vehicle match is optionally accessed in order to locate relevant inspection tasks for inclusion or removal from the smart inspection checklist. For example, a first driver profile may match drivers that are female and above the age of 45. For these drivers, the trending data may indicate that brake pads should be checked at each inspection, regardless of the type of vehicle that is presented for inspection. In one embodiment, driver attributes and vehicle attributes may be considered by the trending module 120 in order to determine trends that for a particular inspection vehicle.

In block 450, a smart inspection checklist is generated and/or recommended inspection tasks for a particular inspection vehicle are compiled in a data structure that may be used by the inspection facility 180 in order for them to generate an inspection checklist. The smart inspection checklist may be transmitted in any format, such as in a PDF, CSV, TXT, JPG, or XML file, for example, or any other format that is readable by the automobile inspection facility 180. Upon receiving the smart inspection checklist and/or inspection tasks, the automobile inspection facility 180 may perform an inspection based on the inspection tasks listed in the smart inspection. In an advantageous embodiment, the smart inspection checklist includes items of particular interest for the specific inspection vehicle, based on at least the trended repair and/or repair recommendation data generated by the trending module 120 of the smart inspection module 100.

In one embodiment, the smart inspection module 100 orders the inspections tasks for a particular inspection vehicle according to a logical order of inspection that will be performed by the technician. For example, inspection tasks for a particular vehicle system may be grouped. Likewise, inspection tasks that require a particular vehicle configure, e.g., hood open, raised on stands, etc., may be grouped to minimize repetitive labor by the technician.

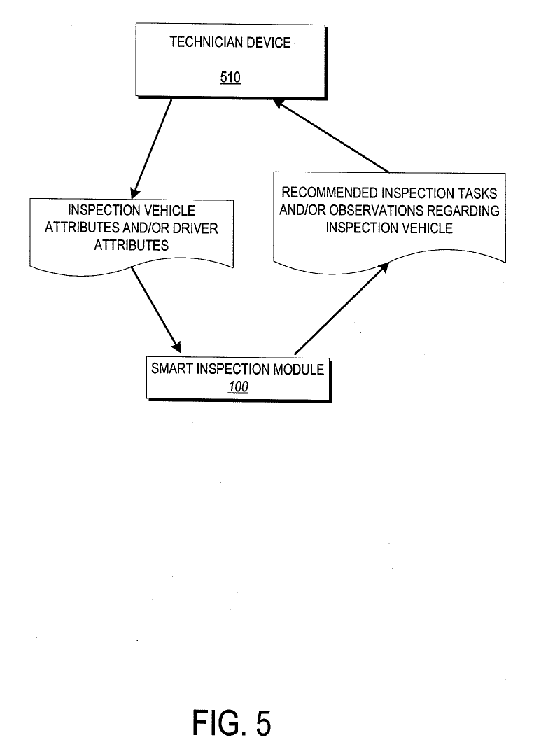

FIG. 5 is a block diagram illustrating an exemplary exchange of data between a technician device 510, such as a mobile device that is operated by an inspection technician (e.g., a mechanic) at the repair facility 180, and the smart inspection module 100. As noted above, in one embodiment vehicles are presented to technicians at the repair facility 180 with a request for inspection of the vehicles. In one embodiment, the technician enters vehicle and/or driver attributes into a computing device, such as a personal digital assistant, tablet PC, or desktop computing device. As illustrated in FIG. 5, these attributes are transmitted to the smart inspection module 100. In response to receiving the vehicle and/or driver attributes, the smart inspection module 100 generates one or more recommended inspection tasks for the inspection vehicles and outputs the recommended inspection tasks to the repair facility 180. In one embodiment, the recommended inspection tasks are sorted according to importance of the inspection tasks, such as a likelihood that the inspection task would result in necessary repair work for the particular inspection vehicle. In other embodiments, the inspection tasks are arranged in categories. In one embodiment, observations regarding the inspection vehicle, such as informational items regarding the vehicle that do not necessarily require additional inspection and/or repair, may be provided to the technician device 510 so that the driver of the inspection vehicle may be presented with additional value-added information regarding his particular vehicle.

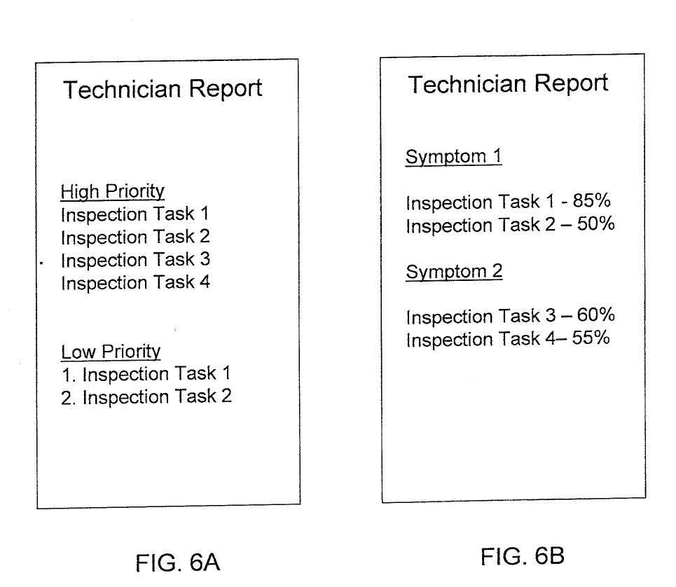

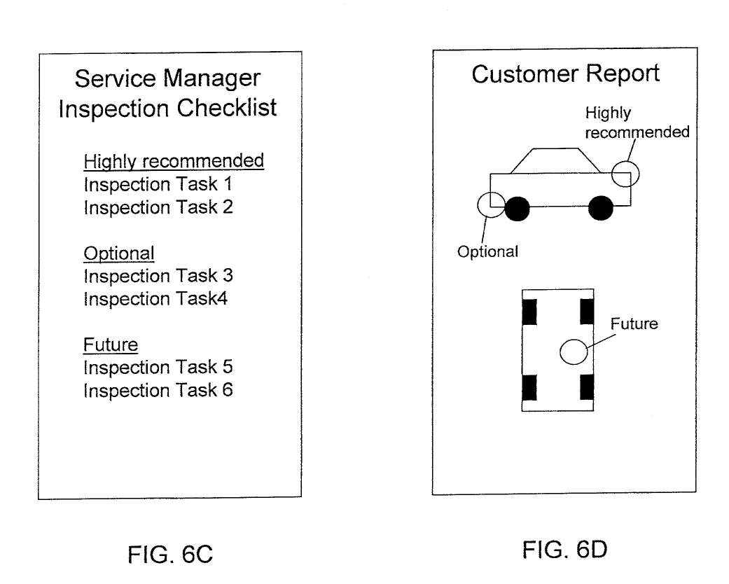

FIGS. 6A-6D illustrate exemplary embodiments of smart inspection checklists. In certain embodiments, the content of the smart inspection checklists may be tailored, based upon the recipient of the report, such as different formats for each of service managers, customers, and mechanics/technicians, so that tasks that are particularly significant may be emphasized for the recipient of the checklist. For example, in one embodiment, smart inspection checklists are in a form similar to the Factory Graphical preferred format. In one embodiment, the technician to perform the inspection is provided a smart inspection checklist in a list-type format, while the service advisor is provided with an inspection checklist for presentation to the customer in a factory-preferred graphical layout. In another embodiment, the technician is provided a smart inspection checklist in the familiar, factory-preferred format, while the service advisor is provided with an inspection checklist for presentation to the customer in a list-style layout. Furthermore, different tasks may be emphasized for each person.

In one embodiment, technician reports of FIGS. 6A and 6B may comprise a plurality of inspection tasks, determined by the inspection module 100 as discussed above, and provided in a list-type format. For example, inspection tasks that are of highest priority to inspect may be placed at the top of an ordered list, as illustrated in FIG. 6A. In one embodiment, if the technician is diagnosing a specific symptom of an inspection vehicle, inspection tasks on the smart inspection checklist may be presented in order of likelihood of success in resolving the problem, as illustrated in FIG. 6B, for example. In other embodiments, the technician reports may comprise additional or less information regarding each of the recommended tasks.

In one embodiment certain of the tasks indicate a quantity of other similar vehicles for which the particular inspection task received a “fail” response from the respective inspection technician. Thus, a technician report may indicate that 200 out of 600 (or 33.3%) vehicles of the same make and model as the inspection vehicle resulted in a “fail” response to the “check the attachment of the muffler” inspection task. The technician report may further, or alternatively, indicate that 102 out of 150 (or 68%) vehicles of the same make, model, and year as the inspection vehicle resulted in a “fail” response to the same “check the attachment of the muffler” inspection task. Thus, statistics for various groups of vehicle and/or driver attributes may be provided on the technician report, allowing the technician to make better decisions for prioritizing completion of inspection tasks.

FIG. 6C illustrates an exemplary service manager inspection checklist, which comprises a plurality of inspection tasks recommended by the smart inspection module 100 in one or more of the manners discussed above. In the embodiment of FIG. 6C, inspection tasks are ranked in order of severity. For example, inspections tasks associated with critical vehicle systems or systems likely to fail in a short time frame may be placed in a “highly recommended” category. The service manager may choose to strongly advocate the performance of these services. Alternatively, inspections tasks associated with non-critical vehicle systems or systems that are unlikely to fail in a short time frame may be placed in an “optional” category. The service manager may choose to recommend these services, as being necessary at some point but not immediately necessary to perform. In embodiment of FIG. 6C, the smart inspection checklist further comprises a list of recommended future inspection tasks. The future services may comprise inspection tasks that the inspection module 100 determines will be, but are not presently, highly recommended. Thus, the service manager may make the customer aware of upcoming inspections and repairs.

In one embodiment, any of the smart inspection reports may sub-divide inspection tasks according to likelihood of success of a recommended repair. The technician or service manager may employ data regarding the likelihood of success of an inspection or repair as a further tool in their advocacy.

Advantageously, with this information, the service manager may be a strong advocate for necessary inspections and repairs. At the same time, however, the service manager may be knowledgeable about optional inspections and repairs. The service manager may be further informed about the relative likelihood of success of a repair associated with a recommended inspection task. Taken together, this information allows the service manager to be focused on the customer's needs and preferences, maximizing the likelihood of positive results and return business.

One embodiment of a customer report is illustrated in FIG. 6D. The customer report may contain at least a portion of the information provided in the exemplary technician report (FIGS. 6A and 6B) and/or service manager report (FIG. 6C, such as inspection tasks grouped into highly recommended and optional categories), as discussed above. In one embodiment, the customer inspection report is presented to the customer in graphical form, for ease of understanding by the customer, as illustrated in FIG. 6D. In alternative embodiments, the customer report may be provided in a list-type format, such as that provided in the technician reports of FIGS. 6A and 6B, for example.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A computerized method of generating a customized inspection checklist for a particular vehicle, the method comprising:
determining one or more of a year, make, and model, of a particular vehicle presented at an inspection facility for inspection;
locating inspection data for a plurality of similar vehicles each having one or more of a year, make, and model the same as the determined year, make, and model of the particular vehicle, wherein the inspection data comprises a plurality of inspection tasks and corresponding inspection results for the similar vehicles;
locating one or more inspection tasks of the inspection data for which a predetermined portion of the inspection results associated with the similar vehicles indicate that one or more repairs or further inspection should be performed on the respective similar vehicles; and
generating a customized inspection checklist including the located inspection tasks.

2. The method of claim 1, wherein the customized inspection checklist comprises only the located inspection tasks.

3. The method of claim 1, wherein the similar vehicles were each in the same mileage range when their respective inspection results were records as a current mileage range of the particular vehicle.

4. The method of claim 1, wherein the similar vehicles are each the same sub-model as the particular vehicle.

5. The method of claim 1, wherein the similar vehicles each have a common accessory package as the particular vehicle.

6. The method of claim 1, wherein the similar vehicles were each purchased in a common date range as the particular vehicle.

7. The method of claim 1, further comprising:
determining one or more attributes of a driver of the particular vehicle;
determining a driver profile associated with the one or more attributes, wherein each of a plurality of driver profiles is associated with respective inspection tasks;
locating one or more inspection tasks associated with the determined driver profile; and
including the located inspection tasks on the generated customized inspection checklist.

8. The method of claim 7, wherein the driver attributes comprise indications of one or more of a profession, driving style, use of the vehicle, geographical region where the vehicle is operated, and the climate of the geographical region where the vehicle is operated.

9. The method of claim 1, further comprising:
determining one or more attributes associated with historical inspections or repairs of the particular vehicle;
analyzing the historical attributes in order to determine one or more inspection tasks for the particular vehicle; and
appending the determined inspection tasks to the customized inspection checklist.

10. The method of claim 1, further comprising analyzing vehicle-related data from one or more of consumers, technicians, government agencies, and independent test laboratories, in order to determine one or more additional inspection tasks to be included in the customized inspection checklist.

11. The method of claim 1, wherein the similar vehicles have one or more of a common make, model, year, sub-model, engine specifications, and accessory package as the particular vehicle.

12. A method of determining inspection tasks for inclusion in an inspection checklist for a particular vehicle, the method comprising:
accessing a data structure comprising indications of a plurality of inspection tasks and associations between respective inspection tasks and respective combinations of one or more of a year, make, and a model of a vehicle; and
selecting a first plurality of inspection tasks that are associated with a particular vehicle in the data structure.

13. The method of claim 12, wherein certain of the inspection tasks are included in the data structures in response to determining that a repair associated with respective of the certain inspection tasks is common for the vehicles having the same year, make, and/or model.

14. The method of claim 12, further comprising accessing repair data indicating one or more repairs and/or repair recommendations for the particular vehicle and, in response to analyzing the repair data, performing one or more of:
selecting one or more additional inspection tasks for inclusion in the inspection checklist for the particular vehicle; and
removing one or more selected inspection tasks from the inspection checklist for the particular vehicle.

15. A system for generating an inspection form for use by an automotive technician, the system comprising:
a computing device configured to receive attributes associated with a particular vehicle;
a server in data communication with the computing device, the server storing information regarding repairs that have previously been made to vehicles similar to the particular vehicle, wherein the server provides an indication of those repairs that have been made on similar vehicles at least a threshold number of times and the computing device generates the inspection form comprising inspection recommendations that correspond with the repairs indicated by the server.

16. The system of claim 15, wherein the server stores information regarding repair recommendations that have previously been made to vehicles similar to the particular vehicle, wherein the server provides an indication of those repair recommendations that have been made on similar vehicles at least a threshold number of times and the inspection form generated by the computing device comprises inspection recommendations that correspond with the repair recommendations indicated by the server.

17. The system of claim 15, wherein the computing device comprises a portable computing device that is operated by an automotive technician.

18. The system of claim 15, wherein the threshold number of times is determined based on a percentage of similar vehicles for which repair data is stored by the server.
